(19) United States
(12) Patent Application Publication
(10) Pub. No.: US 2019/0247952 A1
(43) Pub. Date: Aug. 15, 2019

(54) LASER CUTTING HEAD COMPRISING A BODY MADE OF TWO PARTS, BEING LINKED TOGETHER BY A FLEXIBLE MEMBER

(71) Applicant: POWER-TECH JANUSZ MARCIN EJMA, Walcz (PL)

(72) Inventor: Janusz EJMA, Walcz (PL)

(73) Assignee: POWER-TECH JANUSZ MARCIN EJMA, Walcz (PL)

(21) Appl. No.: 16/329,220

(22) PCT Filed: Aug. 11, 2017
(86) PCT No.: PCT/IB2017/054925

§ 371 Date: Feb. 28, 2019

(30) Foreign Application Priority Data
Aug. 30, 2016 (PL) P.418503

(51) Int. Cl. B23K 26/046; B23K 26/08; B23K 26/14; B23K 26/38; B23K 26/06; B23K 37/02

(52) U.S. Cl. CPC B23K 26/046; B23K 26/0884; B23K 26/1476; B23K 37/0235; B23K 26/38; B23K 26/0643; B23K 26/1482

(57) ABSTRACT

A laser cutting head includes a body, a laser light source located at a first end of the body, a nozzle located at another end of the body, an optical system located inside the body between the laser light source and the nozzle. The body includes at least two parts, which are slidable relative to each other in such a way that, due to their reciprocal displacement, the mutual position of the laser light source and/or the nozzle and/or the optical system can be changed, so that the geometry of the laser beam inside the body can be changed during use to achieve the desired parameters of the focus of the laser beam on the surface of the workpiece.

### CROSS REFERENCE TO RELATED APPLICATIONS

This application is the national phase entry of International Application No. PCT/IB2017/054925, filed on Aug. 11, 2017, which claims priority to the Polish patent application No. P.418503, filed on Aug. 30, 2016, the entire contents of which are incorporated herein by reference.

### TECHNICAL FIELD

The subject of the invention is a laser cutting head, in particular for laser cutting of metal parts, as well as a laser cutter comprising such a head.

### BACKGROUND

Laser cutting heads are known for use in laser cutters, which employ a laser beam and compressed gas to cut metal pieces. Such a head comprises an optical system, essential for focusing the laser beam at a suitable location on the workpiece surface. The Chinese utility model CN202607091U discloses a tiltable laser cutting head with adjustable laser beam focus. In said head's lens assembly, a reflective lens is located, with variable curvature, and it is connected to the lens cone in a mechanical adjustment mode. This oscillating laser cutting head with the laser beam focus adjustment can quickly move the laser beam focus, depending on the different laser processing requirements, and can automatically tilt the head to produce a high-quality trapezoid weld shape with high efficiency. Another Chinese utility model CN202028872U discloses a laser cutting head with a focus adjustment with a drawer-like mount. It is characteristic for this laser cutting head that a pressure ring is set in the lens housing, the focus adjustment lens is placed in a small lens drawer, and this small drawer is placed in the center of the laser head. Document CN102497952B discloses a laser cutting head that comprises a camera with an imaging lens system set in front of the camera in the laser beam path to watch the machined workpiece area, with a lens system for focusing the working laser beam on the workpiece surface or on a designated area thereof, and with an analyser unit designed to calculate the offset correction by adjusting the imaging lens system's setting in the direction of the optical axis to shift the camera image focus. Document WO2011004084A1 discloses a laser beam focusing head comprising a main body with a cavity designed to receive the focusing lens cartridge. The mount system comprises at least one movable locking cam, which is set in the cartridge, and at least one first follower lock, which is set in the main body. The cam lock can move between at least one mounting position, in which the movable cam mechanically connects at least with the first cam follower to secure the cartridge inside the main body's recess. Document CN102039490A discloses a laser cutting head that comprises a base, a connector, a focusing mirror element, a condenser head, and a blow nozzle, and also comprises a collision protection mechanism, an autofocus mechanism, and a water cooling ring. The focusing mirror element comprises a first mirror recess and a second mirror recess provided with mirror bases of retractable type. The working head is equipped with double mirror bases, and a 5-inch focusing mirror or 7.5-inch focusing mirror can be installed manually. The cutting head has an auto focus feature, and can be programmed to adjust the focus. All above mentioned solutions comprise movable elements of the optical system inside the laser cutting head. When moving, such movable elements cause the wear of the contacting elements, and consequently, the formation of dust or particles of wiped-off material which, over time, deposit on the optical system's elements. If the optical system elements are interchangeable, their replacement may additionally cause the ingress of dirt from the outside to the optical system. Such dirt causes the laser beam to dissipate or interferes with its path, which has a very strong effect on the laser beam focus in the desired location. The laser beam's failure to properly focus on the workpiece surface decreases the effective power needed to cut the workpiece, slows the cutting process down, and decreases the quality of the cut that manifests itself in uneven edges and/or undercuts or burrs on the workpiece edges. The biggest problem with dirt or the effect of thereof is the so-called “focus shift”, which means the laser beam's relocation. Instead of going through the optical system without interference, the laser beam is absorbed by the dirt on the optics, which causes the optics to heat up, often unevenly. This changes the optics' geometry and shifts the beam's focus, as well as deteriorates its parameters. What is more, the optics' heating up also results in the formation of an additional unwanted thermal lens or other disturbances over the heated lens, which means that the heated gas over the lens also adversely affects the beam's quality. The higher the power, the more sensitive the lens is to dirt, and the greater the impact on the cutting process. The optics' cleanliness is the most critical parameter.

Therefore, the present invention aims to provide a laser cutting head that limits or eliminates the said drawbacks of the known laser cutting heads, in particular the laser cutting heads for metal components, as well as a laser cutter comprising such a head.

### SUMMARY

The subject of the invention is a laser cutting head comprising a body, a laser light source located at the first end of the body, a nozzle that is set at the other end of the body, an optical system that is set inside the body between the laser light source and the nozzle, in such a way, that during operation the laser beam passes from the laser light source through the optical system and then through the nozzle. The laser cutting head, according to the invention, is characterized in that the body comprises at least two parts, which are slidable relative to each other in such a way that, due to their reciprocal displacement, the mutual placement of the laser light source and/or the nozzle and/or the optical system can be changed, so that the geometry of the laser beam inside the body can be changed during use to achieve the desired parameters of the laser beam focus on the workpiece surface. The mutual displacement of at least two body parts takes place along and/or across the body's optical axis. The first body part may be integrated with the laser light source and the second body part may be integrated with the nozzle, while the first body part is slidable relative to the second body part along and/or across the head's optical axis in such a way that ensures at least the range of the first body part's movement relative to the second body part that is required to achieve the desired parameters of the laser beam focus on the workpiece surface. The mutual movement and accurate positioning of the adjacent body parts is effected with coupling means slidable relative to each other. Two, three or more body parts can be moved simultaneously relative to each other. The precise sliding movement of the adjacent body parts can be ensured by any suitable motor, such as a stepper motor controlled by a control system. Preferably, at least the first body part is connected to the second body part by means of a flexible and hollow shielding member in the form of a sleeve or bellows having a sealed outer jacket, and the first opening with the first rim sealed to the first body part opposite to the part integrated with the laser light source, and the second opening with the second rim sealed to the second body part integrated with the nozzle, in such a way that during operation, the first body part can be moved relative to the second body part along and/or across the head's optical axis with ensured sealing from the surroundings of the head's inner space between the laser light source and the first optical element, viewed from the laser light source side. Inside the head's inner space there are no moving parts which, when rubbing against each other, could produce dirt particles. The said bellows do not generate friction and do not produce any dirt. In addition, the said bellows is also flexible in the transverse direction to the head's optical axis and enables the movement of the adjacent body parts in the transverse direction to the head's optical axis. When the body parts are moving relative to each other, the flexible and hollow shielding member is deformed, e.g. by a larger or smaller bulge in the direction perpendicular to the head's optical axis. This head design ensures that there are no moving parts inside the head, what ensures that there is no friction between the elements and no dirt is generated in the head's sealed inner space between the laser light source and the first optical component viewed from the laser light source. The flexible hollow shielding member can be made of any elastic material that does not generate impurities when deformed, such as plastic or rubber. The flexible hollow shielding member can also be made as accordion-like bellows. In such a case, the accordion-like bellows' components can be made as substantially rigid, connected by flexible couplings to ensure tightness. Such bellows designs are known and need no further explanation. The optical system may consist of one or more optical elements in the form of an optical lens, i.e. a body with at least one curved boundary surface, made of a transparent material, designed for focusing or dispersing a light beam by means of the phenomenon of refraction at the media boundary, set centrally and perpendicularly to the head's optical axis within one and/or many body parts. Preferably, at least two elements of the optical system are set each in a separate body part. Preferably, the optical elements are on their peripheries tight-set on the inner surface of the respective body part. Preferably, at least the second body part also comprises a connection for connecting a conduit with compressed gas, e.g. oxygen, argon or nitrogen, and at least one opening in the shell of the second body part, tight-tied to the said connector, arranged so that, during operation, the compressed gas stream prevents the deposition of impurities on the surface of the first optical element or the protective glass, viewed from the nozzle side, and then exits through the nozzle outside the head towards its optical axis. The head may comprise 3, 4 or more body parts connected by the bellows as described above and moving relative to each other with respect to the longitudinal axis and the transverse axis of the head alike, in such a way that, during operation, the stream of compressed gas is led directly or indirectly, e.g. after bouncing off the second body part's inner surface, to the surface of the first optical element, viewed from the nozzle side, and then exits through the nozzle outside the head in the direction of its optical axis. The first element of the optical system may be a transparent cover. Preferably, the said transparent cover may be made of glass, e.g. quartz glass or lead glass, and may be interchangeable. Preferably, the nozzle is made removable and can be detachably connected to the second body part, with the possibility of centering or moving perpendicularly to the head's optical axis and/or along its optical axis. During operation, the nozzle may be automatically replaced by a nozzle with other parameters, in particular other dimensions of the nozzle opening and/or other nozzle length along the head's optical axis. The nozzle can be automatically replaced in such a way that it is connected to the second part of the head body by means of a quick-release coupler and it can be replaced after the head has been moved to a place outside the working area or in the working area where properly positioned in their slots are nozzles with other parameters. If needed, the head moved by control system can automatically leave the existing nozzle in a free slot and can pick-up a nozzle with other parameters. Preferably, the head comprises the fixings necessary for its attachment to the laser cutter for the head's moving and positioning along the reference system axis. The head is moved and positioned by a mechanical system controlled by a numerically programmable control system with a user panel for data input. Such mechanical systems are known and will not be further described here. The nozzle is centered relative to the head's optical axis by immobilizing at least the nozzle with respect to the reference system axis and moving relative to the reference system axis of at least that part of the body to which the nozzle is slidably attached and/or moving the laser light source relative to the optical system and/or the nozzle.

The essence of the invention is also a laser cutter comprising a laser cutting head with the above-described characteristics. Laser cutters as such are known in the prior art and need not be described more accurately here. Preferably, the nozzle is centered relative to the head's optical axis by immobilizing the nozzle relative to the reference system axis and moving relative to the reference system axis of that body part to which the nozzle is slidably attached or another part of the body, by means of one or more laser cutter drives responsible for movement of the head in one or more axes of the reference system.

### BRIEF DESCRIPTION OF THE DRAWINGS

The invention is explained in more detail by way of example and in the drawing, where:

FIG. 1 schematically shows a perspective view of the laser cutting head,

FIG. 2 schematically shows a longitudinal section of the laser cutting head, showing the laser beam's path through the optical system in the position with no laser beam focus on the workpiece surface,

FIG. 3 schematically shows a fragment of the longitudinal section of the laser cutting head nozzle, showing the laser beam's path through the optical system in the position with laser beam focus on the workpiece surface,

FIG. 4 schematically shows a perspective view of the exchangeable nozzle, showing its connector,

FIG. 5 schematically shows a top view of the laser cutter comprising the head according to the invention,

FIG. 6 schematically shows a front view of the laser cutter comprising the head according to the invention, and

FIG. 7 schematically shows a side view of the laser cutter comprising the head according to the invention.

### LIST OF REFERENCE SIGNS

1—laser cutting head
2—body
3—laser light source
4—the first end of body
5—body
6—nozzle
7—the second end of body
8—optical system
9—laser beam
10—the first part of body
11—the second part of body
12—optical axis of head
13—shielding member, shielding sleeve, shielding bellows
14—outer jacket
15—the first opening
16—the first rim
17—the second opening
18—the second rim
19—inner space of head
20—connector
21—compressed gas conduit
22—opening
23—first element of optical system
24—nozzle opening
25—fixings
26—laser cutter
27—workpiece
28—distance of nozzle tip from workpiece
29—nozzle length along the optical axis of head
30—nozzle coupler

### DETAILED DESCRIPTION

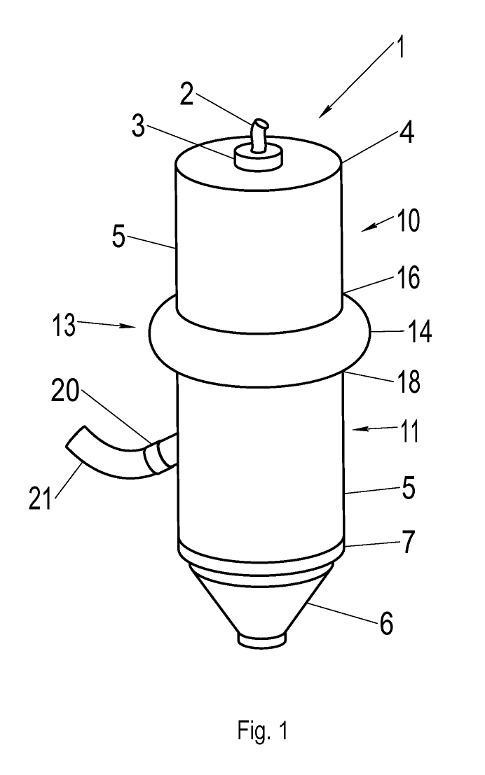

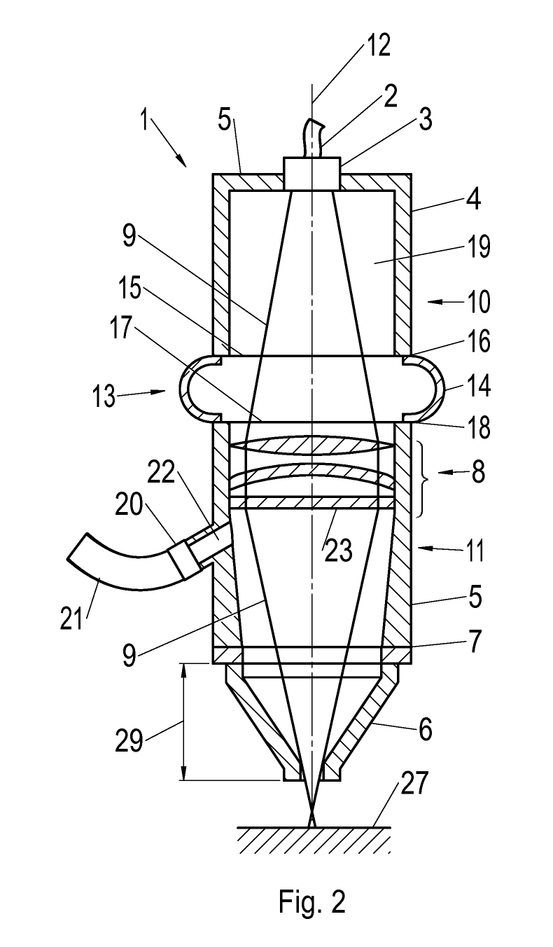

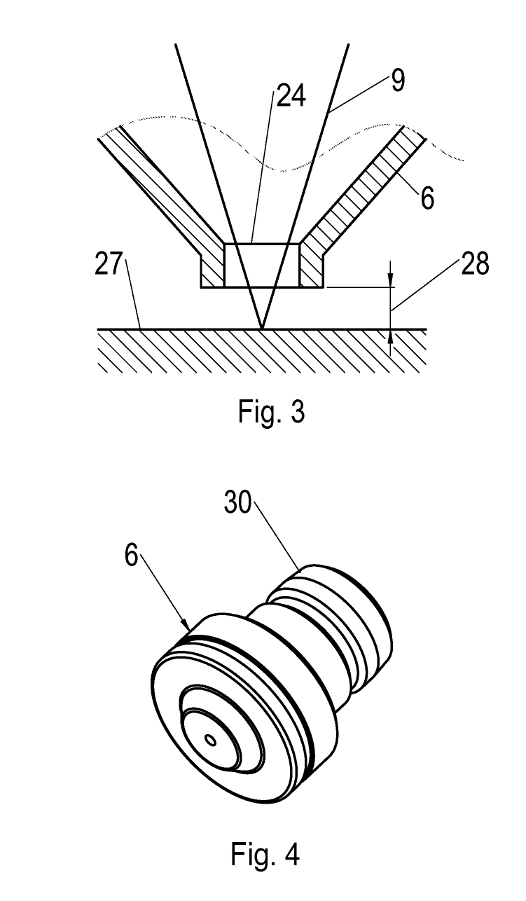

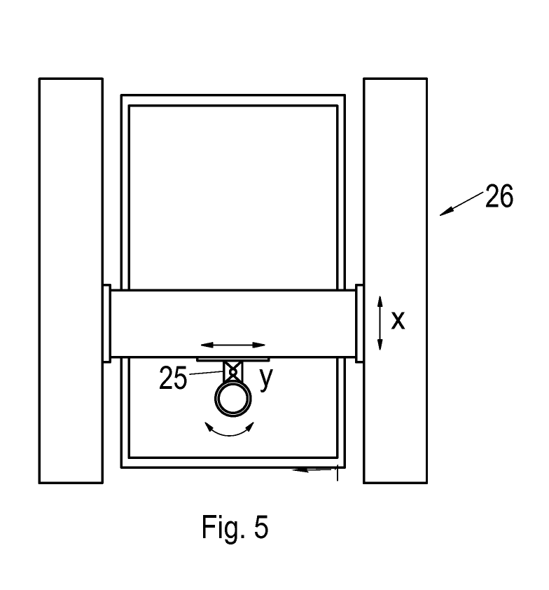

FIG. 1 and FIG. 2 show, respectively, perspective and cross-sectional views of a laser cutting head 1, comprising a laser light source 3 connected to an optical fibre 2 and located at a first end 4 of a body 5, a nozzle 6 located at the other end 7 of the body 5, an optical system 8 inside the body 5 between the laser light source 3 and the nozzle 6 so that during operation the laser beam 9 passes from the laser light source 3 through the optical system 8 and then through the nozzle 6. The body 2 comprises the first part 10 of the body 5 integrated with the laser light source 3 and the second part 11 of the body 5 integrated with the optical system 8 and the nozzle 6. The first part 10 of the body 5 is slidable relative to the second part 11 of the body 5 along and across the optical axis 12 of the head 1 to provide the range of movement of the first part 10 of the body 5 relative to the second part 11 of the body 5 required to control the focus of the laser beam 9 on the workpiece surface 27. The first part 10 of the body 5 is connected to the second part 11 of the body 5 by means of a hollow flexible shielding member 13 in the form of bellows. The bellows 13 have a sealed outer jacket 14 and a first opening 15 with a first rim 16 sealed to the first part 10 of the body 5 opposite to the part integrated with the laser light source 3, and a second opening 17 with a second rim 18 sealed to the second part 11 of the body 5, integrated with the optical system 8 and the nozzle 6, in such a way that during operation the first part 10 of the body 5 can be moved relative to the second part 11 of the body 5 along and across the optical axis 12 of the head 1 with the assurance of tight sealing from the surroundings of the inner space 19 of the head 1 between the laser light source 3 and the the first optical element 8, viewed from the laser light source 3 side and with the assurance that, when operated, there are no moving parts inside inner the space 19 of the head 1. The laser light source 3 is made in the form of so called “fiber end”, to which the laser light is supplied from the outside of the head 1 by the optical fibre 2. All elements of the optical system 8 are stationary relative to each other and relative to the second part 11 of the body 5. In addition, the second part 11 of the body 5 comprises a connector 20 for connecting a compressed gas conduit 21 and an opening 22 in the second part 11 of the body 5 tight-tied to said connector 20. The opening 22 is positioned is such a way that during operation the stream of compressed gas is directed to the surface of the first element 23 of the optical system 8 as viewed from the nozzle 6 side, and then exits through the nozzle 6 outside the head 1 in the direction of the optical axis 12 of the head 1. Such a positioning of the opening 22 ensures cooling of the optical system 8 and prevents deposition of impurities on the surface of the first optical element 8 viewed from the side of the nozzle 6. The nozzle 6 is made removable and tightly and detachably coupled with the second body part 11, with the possibility of centering with respect to the optical axis 12 of the head 1, and during operation, to allow the proper focus of the laser beam 9 on the surface of the workpiece 27 and to allow the optimum parameters of the gas stream penetrating the workpiece 27, regarding the diameter of the opening 24 of the nozzle 6 and the distance 28 of the tip of the nozzle 6 from the workpiece 27, shown in FIG. 3, may be automatically replaced by the nozzle 6 with other parameters, in particular other dimensions of the opening 24 of the nozzle 6 and the other length 29 of the nozzle 6 along the optical axis 12 of the head 1. FIG. 4 shows a perspective view of the exchangeable nozzle 6 showing a connector 30 of the nozzle 6. The head 1 comprises a fixings 25, shown schematically in FIG. 5, necessary for its attachment to laser cutter 26 for moving and positioning of the head 1.

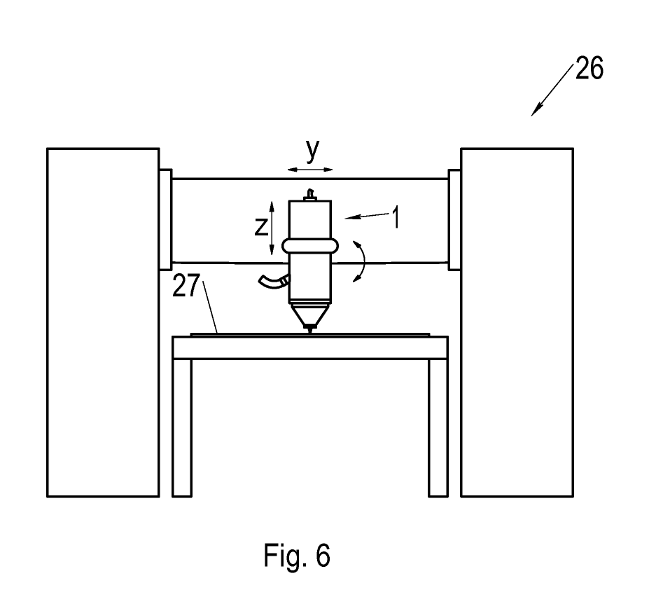

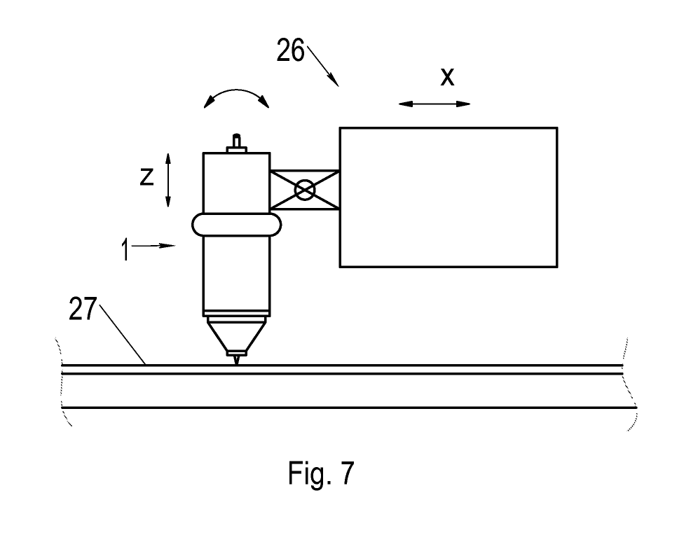

FIG. 5 schematically shows a perspective view of the laser cutter 26 with the head 1 shown in FIGS. 1-4 and described above. FIG. 5, FIG. 6 and FIG. 7 schematically show, respectively, top view, front view, and side view of the laser cutter (viewed from the side of the head 1), showing possible directions of movement of the head 1 (or a laser cutter guides) indicated by arrows. The head 1 can, for example, be so positioned that the laser beam is directed to the workpiece surface 27 at a certain angle.

### INDUSTRIAL APPLICABILITY

With the above-described head 1, the laser cutter 26 provides a faster and more precise process of cutting the workpiece 27 with a smoother and cleaner cut surface compared to the prior art laser cutters, so that further workpiece machining is unnecessary. The advantage of the solution according to the invention is also a narrower cut gap and a smaller heat transfer zone compared to the prior art laser cutters.

1. A Laser cutting head, comprising
a body;
a laser light source located at a first end of the body;
a nozzle located at the other end of the body; and
an optical system located inside the body between the laser light source and the nozzle in such a way that during operation a laser beam passes from the laser light source through the optical system and then the nozzle,
wherein the body comprises at least two body parts of the body which are slidable relative to each other, wherein with a mutual displacement of the two body parts, a position of the laser light source and/or the nozzle and/or the optical system is changed, and wherein, during use, a geometry of the laser beam inside the body is changed to achieve a desired focus of the laser beam on a surface of a workpiece.

2. The head according to claim 1, wherein at least the two body parts are mutually displaceable along and/or across an optical axis of the body.

3. The head according to claim 2, wherein a first part of the two body parts of the body is integrated with the laser light source and a second part of the two body parts of the body is integrated with the nozzle, wherein the first part of the body is slidable relative to the second part of the body along and/or across an optical axis of the head so as to provide a range of movement of the first part of the body required to achieve desired focusing parameters of the laser beam on the surface of the workpiece.

4. The head according to claim 3, wherein at least the first part of the body is connected to the second part of the body by means of a flexible and hollow shielding member with a tight-sealed outer jacket, and a first opening with a first rim sealed to the first part of the body opposites to a part of the first part integrated with the laser light source, and a second opening with a second rim sealed to the second part of the body integrated with the nozzle, wherein during operation the first part of the body is moved relative to the second part of the body along and/or across the optical axis of the head with ensured sealing from surroundings of an inner space of the head between the laser light source and a first element of the optical system, viewed from a laser light source side.

5. The head according to claim 4, wherein the hollow flexible shielding member is made in a form of flexible bellows.

6. The head according to claim 5, wherein at least two elements of the optical system are positioned respectively in the first part and the second part of the body.

7. The head according to claim 6, wherein the second part of the body comprises also a connector for connecting a compressed gas conduit and at least one opening in the second body part tight-sealed to the connector, wherein, during operation, a stream of a compressed gas prevents a deposition of impurities on a surface of the first element of the optical system or a protection glass, as viewed from a nozzle side, and then escapes through the nozzle outside the head towards the optical axis of the head.

8. The head according to claim 7, wherein the nozzle is made as replaceable.

9. The head according to claim 8, wherein the nozzle is detachably connected to the second part of the body with a possibility of centering or moving perpendicularly to the optical axis of the head and/or along the optical axis of the head, and when operated the nozzle is automatically replaced with nozzle with other parameters, in particular with other dimensions of an opening of the nozzle and other nozzle length along the optical axis of the head.

10. The head according to claim 9, wherein the head comprises a fixings necessary for attachment of the head to a laser cutter for moving and positioning the head along a reference system axis.

11. The head according to claim 10, wherein the nozzle is centerable relative to the optical axis of the head by immobilizing at least the nozzle with respect to the reference system axis, and moving relative to the reference system axis of at least a part of the body, to which the nozzle is slidably attached and/or moving the laser light source relative to the optical system and/or the nozzle.

12. A laser cutter, comprising the laser cutting head according to claim 1.

13. The head according to claim 10, wherein the nozzle is centerable relative to the optical axis of the head by means of immobilizing the nozzle relative to the reference system axis, and moving relative to the reference system axis of a part of the body to which the nozzle is slidably attached, or of another part of the body by means of one or more drives of the laser cutter responsible for movement of the head in one or more axes of the reference system axis.
